(19) United States
(12) Patent Application Publication
(10) Pub. No.: US 2023/0366980 A1
(43) Pub. Date: Nov. 16, 2023

(54) RADAR DEVICE AND IN-VEHICLE DEVICE INCLUDING RADAR DEVICE

(71) Applicant: Mitsubishi Electric Corporation, Tokyo (JP)

(72) Inventors: Yusuke KITSUKAWA, Tokyo (JP); Noriyuki FUKUI, Tokyo (JP)

(73) Assignee: Mitsubishi Electric Corporation, Tokyo (JP)

(21) Appl. No.: 18/226,139

(22) Filed: Jul. 25, 2023

Related U.S. Application Data
(63) Continuation of application No. PCT/JP2021/009710, filed on Mar. 11, 2021.

(51) Int. Cl. G01S 7/35; G01S 13/58

(52) U.S. Cl. CPC G01S 7/356; G01S 13/584; G01S 7/354

(57) ABSTRACT

A radar device according to a technique of the present disclosure includes a radar signal generator that intermittently and repeatedly outputs a chirp as a radar signal; a transmitting and receiving antenna that transmits the radar signal and receives, as a reflected wave, the radar signal reflected from an observation target; a beat signal generator that generates a beat signal from the radar signal and the reflected wave; an analog-to-digital converter that converts the beat signal into digital data; and a signal processor that detects range to the observation target and relative velocity with respect to the observation target, using the digital data.

### CROSS REFERENCE TO RELATED APPLICATION

This application is a Continuation of PCT International Application No. PCT/JP2021/009710, filed on Mar. 11, 2021, all of which is hereby expressly incorporated by reference into the present application.

### TECHNICAL FIELD

Techniques of the present disclosure relate to a radar device.

### BACKGROUND ART

The following Patent Literature 1 discloses a radar device of a frequency modulated continuous wave (FMCW) system.

The radar device disclosed in Patent Literature 1 splits a frequency modulated (FM) radar signal into a transmission signal and a local signal, transmits the transmission signal as an electromagnetic wave, and receives, as a reflected wave, the electromagnetic wave reflected by a target.

The radar device disclosed in Patent Literature 1 measures range to an observation target and relative velocity with respect to the observation target from digital data of a beat signal obtained by mixing together the reflected-wave reception signal and the local signal.

The radar device disclosed in Patent Literature 1 performs processes shown below so that even if electromagnetic noise is inputted to an AD converter, degradation of detection accuracy of the observation target is suppressed and true range to the observation target and true relative velocity with respect to the observation target can be measured.

The radar device disclosed in Patent Literature 1 has a period during which a radar signal is transmitted and a period during which a radar signal is not transmitted.

The radar device disclosed in Patent Literature 1 detects an observation target using digital data of a beat signal obtained during the period during which a radar signal is transmitted and digital data of a signal inputted to the AD converter during the period during which a radar signal is not transmitted, thereby preventing erroneous detection of a target.

The radar device disclosed in Patent Literature 1 performs a Fourier transform in a range direction on each of a plurality of pieces of digital data obtained during periods during which repeatedly outputted radar signals are transmitted, thereby calculating a plurality of frequency spectra related to the observation target, performs a Fourier transform in a relative velocity direction on the obtained plurality of frequency spectra, thereby calculating range-velocity spectra related to the observation target, and detects a peak value of spectrum values in the obtained range-velocity spectra, thereby calculating range and velocity information. The Fourier transform in the range direction is called a Range-FFT, also called a range(in KATAKANA)-FFT (hereinafter, called a “range-FFT” in this specification). In addition, the Fourier transform in the relative velocity direction is called a Doppler-FFT, also called a Doppler(in KATAKANA)-FFT (hereinafter, called a “Doppler-FFT” in this specification).

In addition, by performing a range-FFT on each of a plurality of pieces of digital data obtained during periods during which a radar signal is not transmitted, a plurality of frequency spectra related to electromagnetic noise are calculated, and by performing a Doppler-FFT on the obtained plurality of frequency spectra, electromagnetic noise spectra are calculated, and by detecting a peak value of spectrum values in the obtained electromagnetic noise spectra, electromagnetic noise information is calculated.

### CITATION LIST

### Patent Literatures

Patent Literature 1: WO 2020/165952 A

### SUMMARY OF INVENTION

### Technical Problem

The radar device according to prior art exemplified in Patent Literature 1 detects an observation target using the same process for range and velocity information and the above-described electromagnetic noise information, and performs a plurality of Fourier transforms.

An object of techniques of the present disclosure is to improve a radar device in which a signal processing load is reduced by reducing the number of Fourier transforms performed by the radar device.

### Solution to Problem

A radar device according to a technique of the present disclosure includes: a radar signal generator to intermittently and repeatedly output a chirp as a radar signal; a transmitting and receiving antenna to transmit the radar signal and receive, as a reflected wave, the radar signal reflected from an observation target; a beat signal generator to generate a beat signal from the radar signal and the reflected wave; an analog-to-digital converter to convert the beat signal into digital data; and a signal processor to detect range to the observation target and relative velocity with respect to the observation target, using the digital data. The signal processor includes: a frequency converter to perform frequency conversion on a part of the digital data that is obtained during a period during which the radar signal is not outputted; a spectrum calculator to add together a part of the digital data that is obtained during a period during which the radar signal is outputted and the digital data having been subjected to the frequency conversion by the frequency converter, and perform a range-FFT on the added digital data; a range-velocity spectrum calculator to perform a Doppler-FFT on a first half part of results obtained by the spectrum calculator performing the range-FFT; and an electromagnetic noise spectrum calculator to perform a Doppler-FFT on a second half part of the results obtained by the spectrum calculator performing the range-FFT.

### Advantageous Effects of Invention

The radar device according to the technique of the present disclosure has the above-described configuration, and thus, can collectively and simultaneously implement range-FFTs for a period during which a radar signal is transmitted and for a period during which a radar signal is not transmitted, enabling a reduction in the number of Fourier transforms.

### BRIEF DESCRIPTION OF DRAWINGS

FIG. 1 is a configuration diagram showing a configuration of a radar device according to a first embodiment.

FIG. 2 is a configuration diagram showing a configuration of a signal processor of the radar device according to the first embodiment.

FIG. 3 is a flowchart showing a process of calculating range to an observation target and relative velocity with respect to the observation target that is performed by the signal processor according to the first embodiment.

FIG. 4 is an explanatory diagram showing the process of calculating range to the observation target and relative velocity with respect to the observation target that is performed by the signal processor according to the first embodiment.

FIG. 5 is a configuration diagram showing a configuration of a radar device according to a second embodiment.

FIG. 6 is a configuration diagram showing a configuration of a signal processor of the radar device according to the second embodiment.

FIG. 7 is a flowchart showing a process of calculating range to an observation target and relative velocity with respect to the observation target that is performed by the signal processor according to the second embodiment.

FIG. 8 is a configuration diagram showing a configuration of a signal processor of a radar device according to a third embodiment.

FIG. 9 is a flowchart showing a process of calculating range to an observation target and relative velocity with respect to the observation target that is performed by the signal processor according to the third embodiment.

FIG. 10 is an explanatory diagram showing the process of calculating range to the observation target and relative velocity with respect to the observation target that is performed by the signal processor according to the third embodiment.

FIG. 11 is a configuration diagram showing a configuration of a radar device according to a fourth embodiment.

FIG. 12 is a configuration diagram showing a configuration of a signal processor of the radar device according to the fourth embodiment.

FIG. 13 is a flowchart showing a process of calculating range to an observation target and relative velocity with respect to the observation target that is performed by the signal processor according to the fourth embodiment.

FIG. 14 is a configuration diagram showing a configuration of a signal processor of a radar device according to a fifth embodiment.

FIG. 15 is a configuration diagram showing a configuration of a signal processor of a radar device according to a sixth embodiment.

FIG. 16 is a flowchart showing a process of calculating range to an observation target and relative velocity with respect to the observation target that is performed by the signal processor according to the sixth embodiment.

FIG. 17 is an explanatory diagram showing the process of calculating range to the observation target and relative velocity with respect to the observation target that is performed by the signal processor according to the sixth embodiment.

FIG. 18 is a configuration diagram showing a configuration of an in-vehicle device according to a seventh embodiment.

### DESCRIPTION OF EMBODIMENTS

### First Embodiment

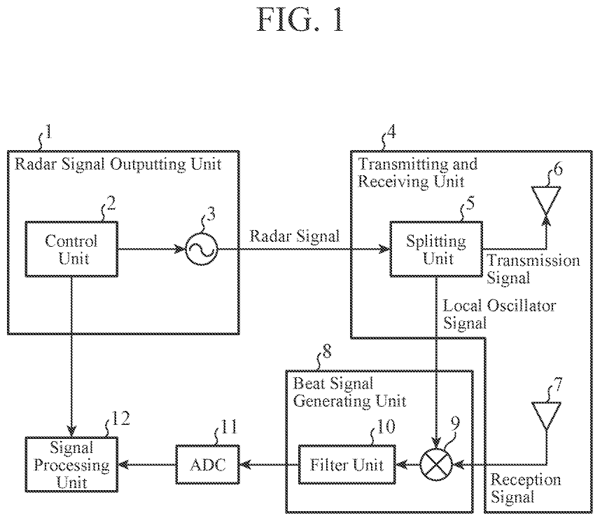

FIG. 1 is a configuration diagram showing a configuration of a radar device 90 according to a first embodiment. As shown in FIG. 1, the radar device 90 according to the first embodiment includes a radar signal generator 1, a transmitting and receiving antenna 4, a beat signal generator 8, an analog-to-digital converter 11, and a signal processor 12.

The radar signal generator 1 includes a controller 2 and a signal source 3.

The transmitting and receiving antenna 4 includes a splitter 5, a transmission antenna 6, and a reception antenna 7.

The beat signal generator 8 includes a frequency mixer 9 and a filter 10.

The radar signal generator 1 is a component that generates a radar signal. The radar signal generated by the radar signal generator 1 is, for example, a frequency-modulated signal whose frequency changes with time. A radar signal is generated intermittently and repeatedly and transmitted to the transmitting and receiving antenna 4.

The controller 2 has the role of generating a timing signal to synchronize the components of the radar device 90. Specifically, the controller 2 outputs a control signal indicating output timing of a radar signal to each of the signal source 3 and the signal processor 12.

The signal source 3 intermittently and repeatedly generates, for example, a frequency-modulated signal as a radar signal, in accordance with the output timing indicated by the control signal outputted from the controller 2. The generated radar signal is outputted to the splitter 5 in the transmitting and receiving antenna 4.

The transmitting and receiving antenna 4 transmits the radar signal outputted from the radar signal generator 1 toward an observation target and receives, as a reflected wave, the radar signal reflected by the observation target. For example, when the radar device 90 is mounted on a vehicle such as an automobile, the observation target corresponds to another automobile, a pedestrian, a guardrail, or the like.

The transmitting and receiving antenna 4 outputs each of the radar signal outputted from the radar signal generator 1 and the reflected wave to the beat signal generator 8.

The splitter 5 splits the radar signal outputted from the signal source 3 into two radar signals, and outputs one of the split radar signals to the transmission antenna 6 and outputs, as a local oscillator signal, the other one of the split radar signals to the frequency mixer 9.

The transmission antenna 6 radiates the radar signal outputted from the splitter 5 into space.

The reception antenna 7 receives, as a reflected wave, the radar signal having been radiated from the transmission antenna 6 into space and then reflected by the observation target, and outputs the received reflected-wave reception signal to the frequency mixer 9.

During a period during which a radar signal is transmitted from the transmitting and receiving antenna 4, the beat signal generator 8 generates a beat signal when the reception antenna 7 receives, as a reflected wave, the radar signal reflected by the observation target. The beat signal has a frequency that is a difference between the frequency of the radar signal transmitted from the transmission antenna 6 and the frequency of the reflected wave. The beat signal may be generated as an IF signal, using a mixer.

The beat signal generator 8 outputs the generated beat signal to the analog-to-digital converter 11.

During a period during which a local oscillator signal is outputted from the splitter 5, the frequency mixer 9 mixes together the local oscillator signal and a reception signal outputted from the reception antenna 7. The frequency mixer 9 generates, from the mixed signal, a beat signal having a frequency that is a difference between the frequency of the local oscillator signal and the frequency of the reflected wave.

The frequency mixer 9 outputs the generated beat signal to the filter 10.

The filter 10 is implemented specifically by a low-pass filter, a band-pass filter, or the like.

The filter 10 suppresses unwanted components such as spurious components included in the beat signal outputted from the frequency mixer 9. The beat signal whose unwanted components have been suppressed is transmitted to the analog-to-digital converter 11.

The analog-to-digital converter 11 converts a beat signal generated by the beat signal generator 8 during a period during which a radar signal is transmitted into digital data, and outputs the digital data to the signal processor 12.

The analog-to-digital converter 11 converts a signal inputted thereto during a period during which a radar signal is not transmitted into digital data, and outputs the digital data to the signal processor 12.

Using the digital data outputted from the analog-to-digital converter 11, the signal processor 12 calculates range to the observation target and relative velocity with respect to the observation target.

Although an amplifier is not mounted on the radar device 90 shown in FIG. 1, an amplifier may be mounted on, for example, an input side of the transmission antenna 6 or an output side of the reception antenna 7.

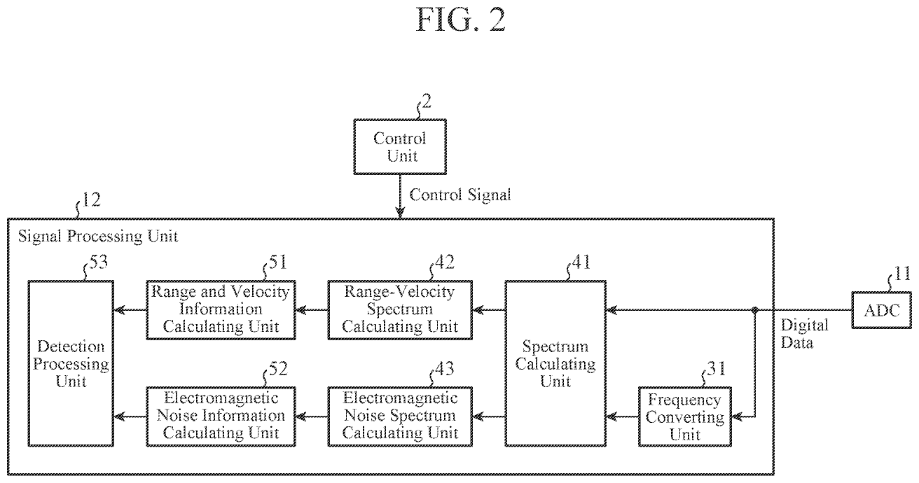

FIG. 2 is a configuration diagram showing a configuration of the signal processor 12 of the radar device 90 according to the first embodiment. As shown in FIG. 2, the signal processor 12 includes a frequency converter 31, a spectrum calculator 41, a range-velocity spectrum calculator 42, an electromagnetic noise spectrum calculator 43, a range and velocity information calculator 51, an electromagnetic noise information calculator 52, and a detection processor 53.

The frequency converter 31 identifies a period during which a radar signal is not outputted from the radar signal generator 1, by referring to a control signal outputted from the controller 2.

The frequency converter 31 performs a process of multiplying digital data obtained during the period identified to have no radar signal out of digital data outputted from the analog-to-digital converter 11, by a complex number. The complex number is a complex number corresponding to a signal of amplitude 1 having a frequency that is n−½ times (n is any integer) a sampling frequency fs (f₀=(n−½)fs). The complex number is represented by the formula “exp(jω₀t)”. Such multiplication of data represented on a time axis by the complex number on a unit circle represented by exp(jω₀t) corresponds to shifting of angular frequency by ω₀=2πf₀ in results of a Fourier transform represented on a frequency axis. A technique of the present disclosure uses a property of the Fourier transform. Specifically, in the technique of the present disclosure, frequency shift is performed only on data related to a period during which a radar signal is not outputted out of all sampled data to make a distinction. The complex number for frequency shift is hereinafter referred to as “frequency shift complex number”. Results of multiplication by the frequency shift complex number are transmitted to the spectrum calculator 41. Note that the above description is made of a case in which multiplication by the complex number is performed for frequency shift, but the technique of the present disclosure is not limited thereto. For example, the real part (e.g., Cos(ω₀t)) of the frequency shift complex number may be used, and the same effect can be obtained.

During periods identified to have no radar signal, digital data from the analog-to-digital converter 11 is repeatedly outputted. The frequency converter 31 repeatedly performs a process of multiplying each of the repeatedly outputted plurality of pieces of digital data by the frequency shift complex number.

The spectrum calculator 41 identifies a period during which a radar signal is outputted from the radar signal generator 1, by referring to the control signal outputted from the controller 2.

The spectrum calculator 41 adds together digital data obtained during the period identified to have a radar signal being outputted out of the digital data outputted from the analog-to-digital converter 11, and the digital data obtained from the frequency converter 31.

The spectrum calculator 41 performs a range-FFT on the added data, thereby calculating a frequency spectrum.

During periods identified to have a radar signal being outputted, both digital data from the analog-to-digital converter 11 and digital data from the frequency converter 31 are repeatedly outputted. The spectrum calculator 41 repeatedly performs the above-described addition process.

The spectrum calculator 41 performs a range-FFT on each piece of added digital data, thereby calculating a plurality of frequency spectra.

The spectrum calculator 41 outputs the calculated plurality of frequency spectra to the range-velocity spectrum calculator 42 and the electromagnetic noise spectrum calculator 43.

The range-velocity spectrum calculator 42 obtains the plurality of frequency spectra outputted from the spectrum calculator 41.

The range-velocity spectrum calculator 42 performs a Doppler-FFT on the first half part of data corresponding to ½ or less of the sampling frequency fs out of the obtained plurality of frequency spectra, thereby calculating range-velocity spectra.

The range-velocity spectrum calculator 42 outputs the range-velocity spectra to the range and velocity information calculator 51.

The electromagnetic noise spectrum calculator 43 obtains the plurality of frequency spectra outputted from the spectrum calculator 41.

The electromagnetic noise spectrum calculator 43 performs a Doppler-FFT on the second half part of data corresponding to a range between greater than ½ and less than or equal to 1 of the sampling frequency fs out of the obtained plurality of frequency spectra, thereby calculating electromagnetic noise spectra.

The electromagnetic noise spectrum calculator 43 outputs the electromagnetic noise spectra to the electromagnetic noise information calculator 52.

The range and velocity information calculator 51 detects a peak value of spectrum values in the range-velocity spectra outputted from the range-velocity spectrum calculator 42.

The range and velocity information calculator 51 outputs, to the detection processor 53, each of a beat frequency and a Doppler frequency related to the range and velocity of the detected peak value.

The electromagnetic noise information calculator 52 detects a peak value of spectrum values in the electromagnetic noise spectra outputted from the electromagnetic noise spectrum calculator 43.

The electromagnetic noise information calculator 52 outputs, to the detection processor 53, each of the frequency of electromagnetic noise and Doppler frequency of the detected peak value.

The detection processor 53 calculates each of true range to the observation target and true relative velocity with respect to the observation target, using two types of frequencies. The two types of frequencies are a beat frequency and a Doppler frequency related to range and velocity that are calculated by the range and velocity information calculator 51; and the frequency of electromagnetic noise and a Doppler frequency that are calculated by the electromagnetic noise information calculator 52.

A process of calculating range to the observation target and relative velocity with respect to the observation target that is performed by the signal processor 12 will become clear from the following specific description.

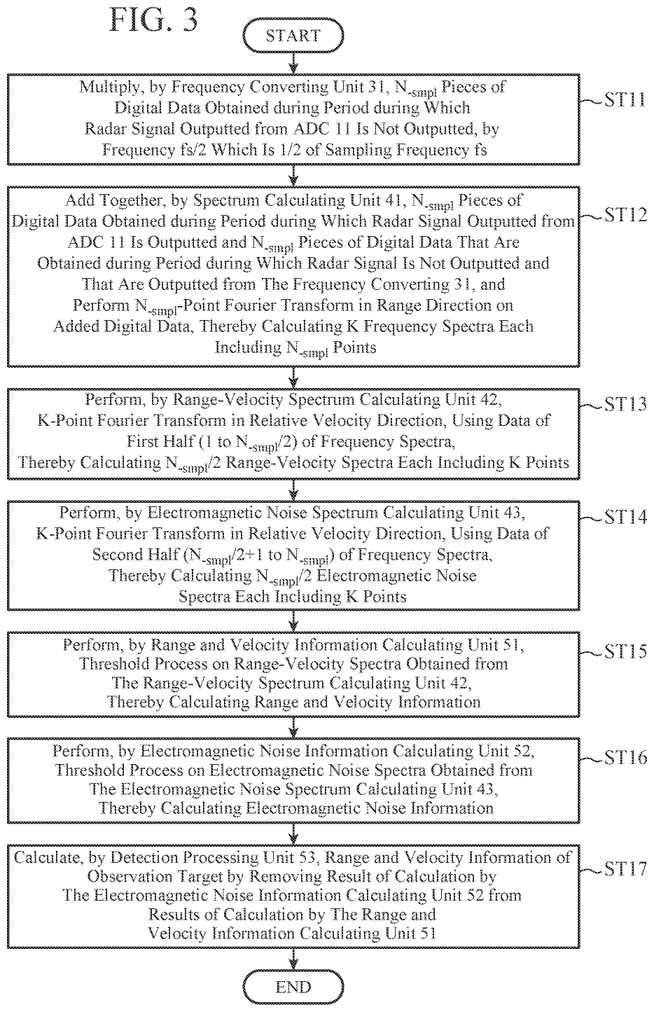

FIG. 3 is a flowchart showing a process of calculating range to the observation target and relative velocity with respect to the observation target that is performed by the signal processor 12.

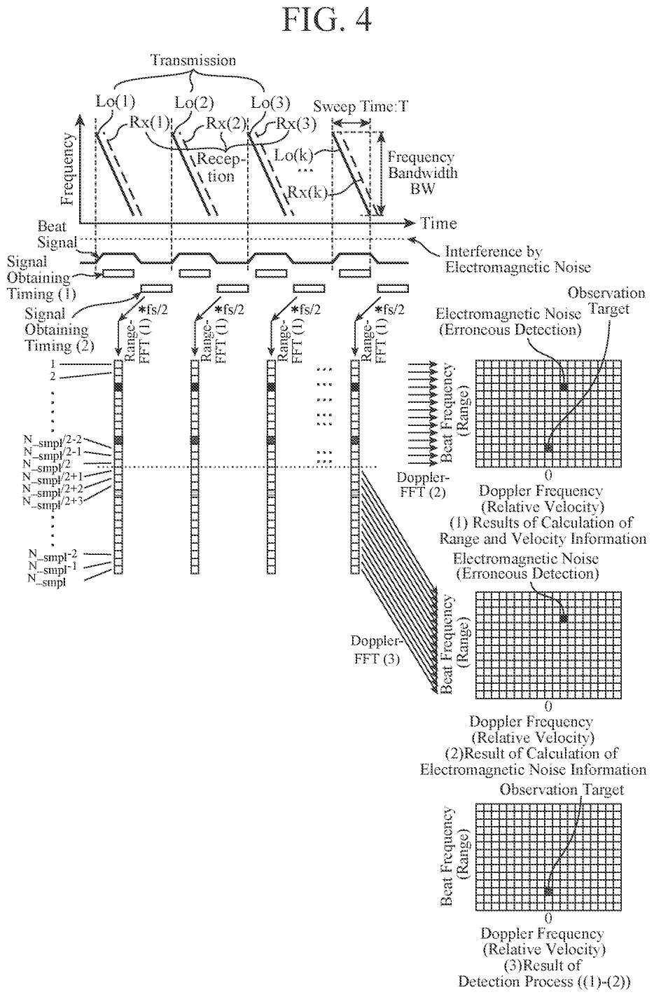

FIG. 4 is an explanatory diagram showing the process of calculating range to the observation target and relative velocity with respect to the observation target that is performed by the signal processor 12.

In FIG. 4, Lo(1), . . . , Lo(K) are local oscillator signals outputted from the splitter 5 to the frequency mixer 9. Although in FIG. 4, an up-chirp is shown as an oscillator signal, the oscillator signal is not limited thereto. The oscillator signal may be a down-chirp or may be a combination of an up-chirp and a down-chirp. In the technique of the present disclosure, oscillator signals are adopted that have idle time between chirps during which a laser signal does not oscillate.

Rx(1), . . . , Rx(K) are reception signals outputted from the reception antenna 7 to the frequency mixer 9.

K is the index number of a chirp and is reset every time range in which a Doppler-FFT which will be described later is performed. Namely, K is the number of chirps in the time range in which a Doppler-FFT is performed. K is an integer greater than or equal to 2.

In an example of FIG. 4, continuous-wave electromagnetic noise of constant frequency is inputted to the analog-to-digital converter 11.

Signal obtaining timing (1) indicates timing at which digital data outputted from the analog-to-digital converter 11 during a period during which a radar signal is transmitted is obtained. The signal obtaining timing (1) is included in a period during which a radar signal is outputted from the radar signal generator 1, and has approximately the same length as one period of a local oscillator signal.

Signal obtaining timing (2) indicates timing at which digital data outputted from the analog-to-digital converter 11 during a period during which a radar signal is not transmitted is obtained. The signal obtaining timing (2) has approximately the same length as one period of a local oscillator signal.

T is the sweep time of the local oscillator signal (Lo(k) (k=1, . . . , K)) and is time in the order of microseconds. BW is the frequency bandwidth of the local oscillator signal (Lo(k)).

For simplification of description, FIG. 4 shows an example in which there is one observation target. However, this is merely an example and there may be two or more observation targets. For simplification of description, FIG. 4 shows an example in which there is one piece of electromagnetic noise. However, this is merely an example and two or more pieces of electromagnetic noise may be inputted to the analog-to-digital converter 11.

The frequency converter 31 identifies a period during which a radar signal is not outputted from the radar signal generator 1, by referring to a control signal outputted from the controller 2.

The frequency converter 31 obtains digital data outputted from the analog-to-digital converter 11, at signal obtaining timing (2) included in the period identified to have no radar signal.

The frequency converter 31 multiplies digital data obtained during the period identified to have no radar signal out of digital data outputted from the analog-to-digital converter 11 by the frequency shift complex number. There are Nₛₘₚₗ (an even number greater than or equal to 2) pieces of data to be multiplied by the frequency shift complex number (step shown at ST11 of FIG. 3).

For simplification of description, FIG. 4 shows an example of multiplication by the frequency shift complex number with the frequency f₀=fs/2. However, this is merely an example, and the frequency of the frequency shift complex number may be n−½ times (n is any integer) the sampling frequency fs.

The spectrum calculator 41 identifies a period during which a radar signal is outputted from the radar signal generator 1, by referring to the control signal outputted from the controller 2.

The spectrum calculator 41 obtains digital data outputted from the analog-to-digital converter 11, at signal obtaining timing (1) included in the period identified to have a radar signal being outputted.

The spectrum calculator 41 adds together Nₛₘₚₗ pieces of digital data obtained during the period identified to have a radar signal being outputted out of the digital data outputted from the analog-to-digital converter 11, and the Nₛₘₚₗ pieces of digital data obtained from the frequency converter 31.

The spectrum calculator 41 performs an Nₛₘₚₗ-point range-FFT on the added digital data, thereby calculating a frequency spectrum (step shown at ST12 of FIG. 3).

In FIG. 4, FFT(1) represents a range-FFT. By performing a range-FFT on digital data, the spectrum value of a reflected-wave reception signal (Rx(k) (k=1, . . . , K)) is added up to a beat frequency (F_{sb_r}) shown in the following equation (1):

F_{sb_r}=2BW·R/c·T (1)

In equation (1), R represents the range from the radar device 90 to the observation target and c represents the speed of light.

By the spectrum calculator 41 performing a range-FFT on the digital data obtained at the signal obtaining timing (1), the spectrum value of electromagnetic noise obtained during the period during which a radar signal is outputted is added up to a point at which the frequency of the electromagnetic noise is F_{n_r}.

The spectrum calculator 41 multiplies the digital data obtained at the signal obtaining timing (2) by the frequency shift complex number with the frequency “fs/2”. The digital data multiplied by the frequency shift complex number is further subjected to a range-FFT. By this processing step, the spectrum value of electromagnetic noise obtained during the period during which a radar signal is not outputted is added up to a point at which the frequency of the electromagnetic noise is F_{n_r}+fs/2.

In the example of FIG. 4, a radar signal is transmitted K times, and thus, the spectrum calculator 41 performs an Nₛₘₚₗ-point range-FFT on different sets of Nₛₘₚₗ pieces of digital data K times. By the K range-FFTs, the spectrum calculator 41 calculates K frequency spectra each including Nₛₘₚₗ points.

The spectrum calculator 41 outputs the calculated K frequency spectra each including Nₛₘₚₗ points to each of the range-velocity spectrum calculator 42 and the electromagnetic noise spectrum calculator 43.

The range-velocity spectrum calculator 42 obtains the plurality of frequency spectra outputted from the spectrum calculator 41.

The range-velocity spectrum calculator 42 performs a K-point Doppler-FFT on data of the first half (1 to Nₛₘₚₗ/2) of the frequency spectra out of the obtained plurality of frequency spectra. By this process, range-velocity spectra each including K points are calculated (step shown at ST13 of FIG. 3).

In FIG. 4, FFT(2) represents a Doppler-FFT. By the range-velocity spectrum calculator 42 performing a Doppler-FFT on K frequency spectra, the spectrum value of the reflected-wave reception signal (Rx(k)) is added up to a Doppler frequency (F_{sb_v}) shown in the following equation (2):

F_{sb_v}=2f·v/c (2)

In equation (2), f represents the center frequency of the local oscillator signal (Lo(k)) and v represents the relative velocity of the radar device 90 with respect to the observation target.

In addition, the spectrum value of the electromagnetic noise is added up to a Doppler frequency (F_{n_v}) corresponding to the relative velocity of the radar device 90 with respect to an electromagnetic noise generation source.

In the example of FIG. 4, continuous-wave electromagnetic noise is inputted to the analog-to-digital converter 11 and the frequency of the electromagnetic noise does not change, and thus, the spectrum value of the electromagnetic noise is added up to the frequency (F_{n_r}) of the electromagnetic noise.

FIG. 4 shows that data of the first half (1 to Nₛₘₚₗ/2) of the frequency spectra is used. Hence, the spectrum calculator 41 performs a K-point Doppler-FFT on different K pieces of digital data Nₛₘₚₗ/2 times, thereby calculating Nₛₘₚₗ/2 range-velocity spectra each including K points.

The range-velocity spectrum calculator 42 outputs the range-velocity spectra to the range and velocity information calculator 51.

The electromagnetic noise spectrum calculator 43 performs a K-point Doppler-FFT on data of the second half (Nₛₘₚₗ/2+1 to Nₛₘₚₗ) of the frequency spectra out of the obtained plurality of frequency spectra. As a result, electromagnetic noise spectra each including K points are calculated (step shown at ST14 of FIG. 3).

In FIG. 4, FFT(3) represents a Doppler-FFT. The electromagnetic noise spectrum calculator 43 adds up the spectrum value of the electromagnetic noise to the Doppler frequency (F_{n_v}) corresponding to the relative velocity of the radar device 90 with respect to the electromagnetic noise generation source.

In the example of FIG. 4, continuous-wave electromagnetic noise is inputted to the analog-to-digital converter 11 and the frequency of the electromagnetic noise does not change, and thus, the spectrum value of the electromagnetic noise is added up to the frequency (F_{n_r}) of the electromagnetic noise.

FIG. 4 shows that data of the second half (Nₛₘₚₗ/2+1 to Nₛₘₚₗ) of the frequency spectra is used. Hence, the electromagnetic noise spectrum calculator 43 performs a K-point Doppler-FFT on different K pieces of digital data Nₛₘₚₗ/2 times, thereby calculating Nₛₘₚₗ/2 electromagnetic noise spectra each including K points.

The electromagnetic noise spectrum calculator 43 outputs the electromagnetic noise spectra to the electromagnetic noise information calculator 52.

When the range and velocity information calculator 51 receives the range-velocity spectra from the range-velocity spectrum calculator 42, the range and velocity information calculator 51 detects a peak value of spectrum values in the range-velocity spectra.

A process itself of detecting a peak value of spectrum values is a publicly known technique and thus a detailed description thereof is omitted here.

The range and velocity information calculator 51 outputs a beat frequency of the detected peak value, as a beat frequency (F_{sb_r}) corresponding to the range to the observation target, to the detection processor 53.

The range and velocity information calculator 51 outputs a Doppler frequency of the detected peak value, as a Doppler frequency (F_{sb_v}) corresponding to the relative velocity with respect to the observation target, to the detection processor 53.

The range and velocity information calculator 51 also detects, as a peak value, the spectrum value of electromagnetic noise obtained during a period during which a radar signal is outputted. Hence, the range and velocity information calculator 51 also outputs the frequency (F_{n_r}) of the electromagnetic noise, as a beat frequency (F_{sb_r}) corresponding to the range to the observation target, to the detection processor 53. In addition, the range and velocity information calculator 51 also outputs the Doppler frequency (F_{n_v}) corresponding to the relative velocity with respect to the electromagnetic noise generation source, as a Doppler frequency (F_{sb_v}) corresponding to the relative velocity with respect to the observation target, to the detection processor 53 (step shown at ST15 of FIG. 3).

When the electromagnetic noise information calculator 52 receives the electromagnetic noise spectra from the electromagnetic noise spectrum calculator 43, the electromagnetic noise information calculator 52 detects a peak value of spectrum values in the electromagnetic noise spectra.

A process itself of detecting a peak value of spectrum values is a publicly known technique and thus a detailed description thereof is omitted here.

The electromagnetic noise information calculator 52 detects, as a peak value, the spectrum value of electromagnetic noise obtained during a period during which a radar signal is not outputted. Hence, the electromagnetic noise information calculator 52 also outputs the frequency (F_{n_r}) of the electromagnetic noise, as a beat frequency (F_{sb_r}) corresponding to the range to the observation target, to the detection processor 53. Here, it is to be noted that the frequency of the spectrum value of electromagnetic noise obtained during a period during which a radar signal is not outputted is F_{n_r}+fs/2 at the time of output from the spectrum calculator 41. The electromagnetic noise spectrum calculator 43 uses, upon performing a Doppler-FFT, data of the second half (Nₛₘₚₗ/2+1 to Nₛₘₚₗ) of first frequency spectra. Hence, the frequency of the spectrum value of the electromagnetic noise is F_{n_r}+fs/2−fs/2=F_{n_r}. In addition, the electromagnetic noise information calculator 52 also outputs the Doppler frequency (F_{n_v}) corresponding to the relative velocity with respect to the electromagnetic noise generation source, as a Doppler frequency (F_{sb_v}) corresponding to the relative velocity with respect to the observation target, to the detection processor 53 (step shown at ST16 of FIG. 3).

The detection processor 53 obtains sets of the beat frequency (F_{sb_r}) and the Doppler frequency (F_{sb_v}) outputted from the range and velocity information calculator 51.

In an example of results of calculating range and velocity information in FIG. 4, there are two peaks corresponding to one observation target and one piece of electromagnetic noise, and thus, the detection processor 53 obtains two sets of the beat frequency (F_{sb_r}) and the Doppler frequency (F_{sb_v}) from the range and velocity information calculator 51.

The detection processor 53 obtains a set of the frequency (F_{n_r}) of the electromagnetic noise and Doppler frequency (F_{n_v}) outputted from the electromagnetic noise information calculator 52.

In an example of results of calculating electromagnetic noise information in FIG. 4, there is one peak corresponding to one piece of electromagnetic noise, and thus, the detection processor 53 obtains one set of the frequency (F_{n_r}) of the electromagnetic noise and the Doppler frequency (F_{n_v}) from the electromagnetic noise information calculator 52.

The detection processor 53 compares information of the two sets obtained from the range and velocity information calculator 51 with information of the one set obtained from the electromagnetic noise information calculator 52.

One of the two sets of the beat frequency (F_{sb_r}) and the Doppler frequency (F_{sb_v}) matches the one set of the frequency (F_{n_r}) of the electromagnetic noise and Doppler frequency (F_{n_v}) obtained from the electromagnetic noise information calculator 52.

Specifically, of the two beat frequencies (F_{sb_r}), one beat frequency (F_{sb_r}) matches the frequency (F_{n_r}) of the electromagnetic noise. In addition, a Doppler frequency (F_{sb_v}) associated with the beat frequency (F_{sb_r}) that matches the frequency (F_{n_r}) of the electromagnetic noise matches the Doppler frequency (F_{n_v})

As shown in FIG. 4, the detection processor 53 discards one of the two sets of the beat frequency (F_{sb_r}) and the Doppler frequency (F_{sb_v}) that matches the set of the frequency (F_{n_r}) of the electromagnetic noise and the Doppler frequency (F_{n_v}).

A result of a detection process of FIG. 4 is an explanatory diagram showing the beat frequency (F_{sb_r}) corresponding to the range to the observation target and the Doppler frequency (F_{sb_v}) corresponding to the relative velocity with respect to the observation target.

The detection processor 53 calculates range to the observation target from a beat frequency (F_{sb_r}) included in a set that remains without being discarded.

The detection processor 53 calculates relative velocity with respect to the observation target from a Doppler frequency (F_{sb_v}) included in the set that remains without being discarded (step shown at ST17 of FIG. 3).

A process itself of calculating range to the observation target from the beat frequency (F_{sb_r}) is a publicly known technique and thus a detailed description thereof is omitted here. In addition, a process itself of calculating relative velocity with respect to the observation target from the Doppler frequency (F_{sb_v}) is also a publicly known technique and thus a detailed description thereof is omitted here.

As described above, the radar device 90 according to the first embodiment has the above-described configuration, and thus, can collectively and simultaneously implement range-FFTs on digital data obtained during a period during which a radar signal is transmitted and during a period during which a radar signal is not transmitted. Hence, the radar device 90 according to the first embodiment can reduce the number of Fourier transforms compared to conventional devices, enabling suppression of degradation of detection accuracy of an observation target.

### Second Embodiment

In the radar device 90 according to the first embodiment, a frequency conversion process on digital data obtained during a period during which a radar signal is not transmitted out of digital data outputted from the analog-to-digital converter 11 is performed by the frequency converter 31 in the signal processor 12.

A radar device 90 according to a second embodiment includes a frequency converter 62. The frequency converter 62 may be constituted by, for example, an analog circuit.

In the second embodiment, the same reference signs as those of the components used in the first embodiment are used, excluding where explicitly stated for a distinction. In addition, in the second embodiment, description that overlaps that of the first embodiment is omitted as appropriate.

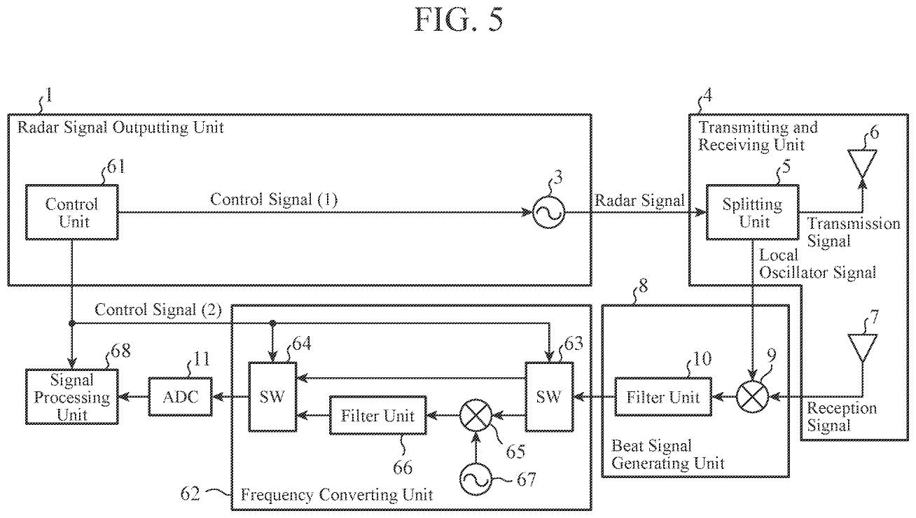

FIG. 5 is a configuration diagram showing a configuration of the radar device 90 according to the second embodiment. As shown in FIG. 5, the radar device 90 according to the second embodiment includes a controller 61, the frequency converter 62, and a signal processor 68 that differ from corresponding ones of the first embodiment.

The controller 61 outputs a control signal (1) that instructs output of a radar signal, to the signal source 3. When the signal source 3 receives the control signal (1) from the controller 61, the signal source 3 outputs a continuous-wave frequency-modulated signal, as a radar signal, to the splitter 5.

In addition, the controller 61 outputs a control signal (2) indicating output timing of a radar signal, to each of the frequency converter 62 and the signal processor 68.

The frequency converter 62 includes a first switch 63, a second switch 64, a frequency mixer 65, a filter 66, and a second signal source 67.

The first switch 63 is connected at its one end to one end on an output side of the second switch 64 and connected at its other end to an input side of the frequency mixer 65.

The first switch 63 repeatedly switches to an input side of the second switch 64 during a period during which a radar signal is outputted, and to the input side of the frequency mixer 65 during a period during which a radar signal is not outputted, in accordance with the output timing indicated by the control signal (2) outputted from the controller 61.

The frequency mixer 65 mixes together a beat signal outputted from the first switch 63 and a local oscillator signal outputted from the second signal source 67, thereby generating a second beat signal having a frequency that is a difference between a frequency of the beat signal outputted from the first switch 63 and the frequency of the local oscillator signal.

The frequency mixer 65 outputs the generated second beat signal to the filter 66.

The filter 66 is implemented by an LPF, a BPF, or the like.

The filter 66 suppresses unwanted components such as spurious components included in the second beat signal outputted from the frequency mixer 65, and outputs the second beat signal whose unwanted components have been suppressed to the second switch 64.

The second signal source 67 is implemented by a local oscillator, a phase locked loop (PLL) synthesizer, or the like. In addition, the second signal source 67 may be implemented using a frequency divider or a multiplier, with a clock signal of the analog-to-digital converter 11 being shared.

The second signal source 67 outputs, to the frequency mixer 65, a local oscillator signal with a frequency (f₀=(n−½)fs) that is n−½ times (n is any integer) a sampling frequency fs.

In the first embodiment, the frequency shift complex number with the frequency f₀ is used, and frequency shift is performed only on data related to a period during which a radar signal is not outputted. In the second embodiment, a local oscillator signal with the frequency f₀ is used in a frequency conversion process. A situation seen in the second embodiment can also be said to be amplitude-modification of oscillation of a local oscillator signal with a single frequency by a reception signal related to a period during which a radar signal is not outputted. Oscillation on a modulated side in the amplitude modulation is called a carrier wave.

The second switch 64 is connected at its one end to the one end on an output side of the first switch 63 and connected at its other end to an output side of the filter 66.

The second switch 64 repeatedly switches to the output side of the first switch 63 during a period during which a radar signal is outputted, and to the output side of the filter 66 during a period during which a radar signal is not outputted, in accordance with the output timing indicated by the control signal (2) outputted from the controller 61.

The second switch 64 outputs, to the analog-to-digital converter 11, the beat signal during the period during which a radar signal is outputted and the second beat signal during the period during which a radar signal is not outputted.

The signal processor 68 calculates each of range to an observation target and relative velocity with respect to the observation target, using digital data outputted from the analog-to-digital converter 11.

Operations of the radar device 90 according to the second embodiment will become clear from the following description with reference to FIGS. 5 to 7.

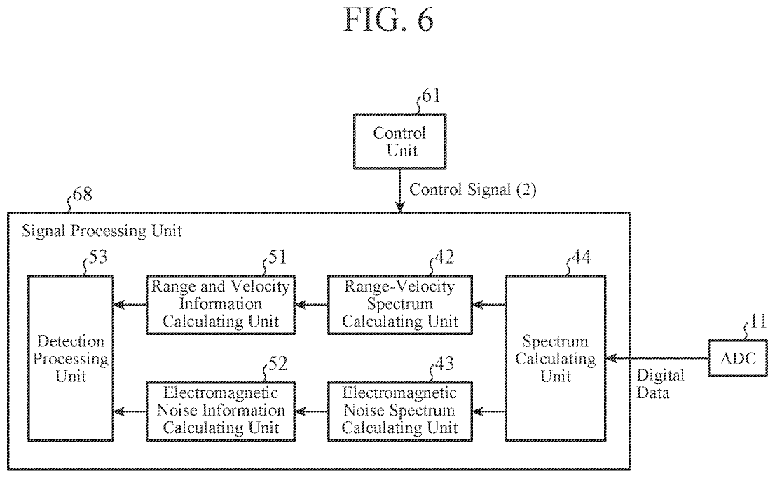

FIG. 6 is a configuration diagram showing a configuration of the signal processor 68 of the radar device 90 according to the second embodiment. As shown in FIG. 6, the signal processor 68 of the radar device 90 according to the second embodiment includes a spectrum calculator 44 different from that of the first embodiment. The signal processor 68 includes the spectrum calculator 44 instead of the frequency converter 31 and the spectrum calculator 41 according to the first embodiment.

The spectrum calculator 44 identifies a period during which a radar signal is outputted from the radar signal generator 1 and a period during which a radar signal is not outputted from the radar signal generator 1, by referring to a control signal (2) outputted from the controller 61.

The spectrum calculator 44 adds together digital data (A) and digital data (B) out of digital data outputted from the analog-to-digital converter 11. The digital data (A) is digital data obtained during the period identified to have a radar signal being outputted. The digital data (B) is digital data obtained during the period identified to have no radar signal.

The spectrum calculator 44 performs a range-FFT on the added data, thereby calculating a frequency spectrum.

Since digital data is repeatedly outputted from the analog-to-digital converter 11, the spectrum calculator 44 repeatedly adds together digital data (A) and digital data (B). The digital data (A) is digital data obtained during a period during which a radar signal is outputted. The digital data (B) is digital data obtained during a period during which a radar signal is not outputted.

The spectrum calculator 44 performs a range-FFT on each piece of the added digital data, thereby calculating a plurality of frequency spectra.

The spectrum calculator 44 outputs the calculated plurality of frequency spectra to the range-velocity spectrum calculator 42 and the electromagnetic noise spectrum calculator 43.

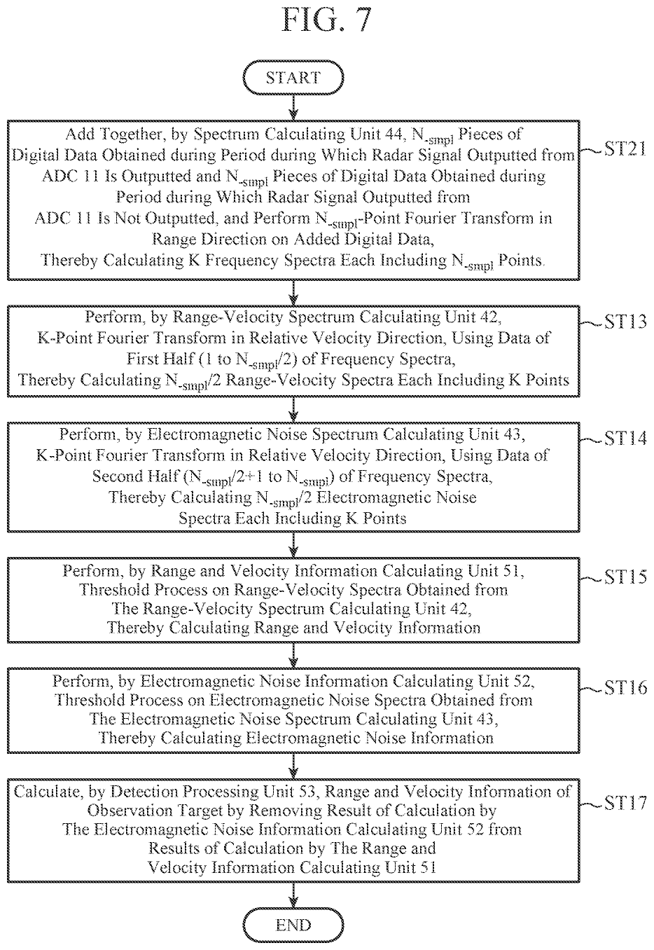

FIG. 7 is a flowchart showing a process of calculating range to the observation target and relative velocity with respect to the observation target that is performed by the signal processor 68 according to the second embodiment.

The spectrum calculator 44 identifies a period during which a radar signal is outputted from the radar signal generator 1 and a period during which a radar signal is not outputted from the radar signal generator 1, by referring to a control signal outputted from the controller 61.

The spectrum calculator 44 obtains digital data outputted from the analog-to-digital converter 11, at signal obtaining timing (1) included in the period identified to have a radar signal being outputted.

The spectrum calculator 44 obtains digital data outputted from the analog-to-digital converter 11, at signal obtaining timing (2) included in the period identified to have no radar signal.

The spectrum calculator 44 adds together digital data (A) and digital data (B) out of digital data outputted from the analog-to-digital converter 11. The digital data (A) is Nₛₘₚₗ pieces of digital data obtained during the period identified to have a radar signal being outputted. The digital data (B) is Nₛₘₚₗ pieces of digital data obtained during the period identified to have no radar signal.

The spectrum calculator 44 performs an Nₛₘₚₗ-point range-FFT on the added digital data, thereby calculating a frequency spectrum (step shown at ST21 of FIG. 7).

As with the spectrum calculator 41 having a configuration shown in the first embodiment, the spectrum calculator 44 performs an Nₛₘₚₗ-point range-FFT on different sets of Nₛₘₚₗ pieces of digital data K times, thereby calculating K frequency spectra each including Nₛₘₚₗ points. The calculated frequency spectra are outputted to the range-velocity spectrum calculator 42 and the electromagnetic noise spectrum calculator 43.

As described above, the radar device 90 according to the second embodiment has the above-described configuration, and thus, can collectively and simultaneously implement range-FFTs on digital data obtained during a period during which a radar signal is transmitted and during a period during which a radar signal is not transmitted. Thus, as with the radar device 90 having a configuration shown in the first embodiment, the radar device 90 according to the second embodiment can reduce the number of Fourier transforms compared to conventional devices, enabling suppression of degradation of detection accuracy of an observation target.

### Third Embodiment

A radar device 90 according to a third embodiment performs a modulation and demodulation process on a beat signal obtained during a period during which a radar signal is not outputted. As a result, range-FFTs can be collectively and simultaneously performed on digital data obtained during both a period during which a radar signal is transmitted and a period during which a radar signal is not transmitted. The collective range-FFTs are performed by a signal processor 71 according to the third embodiment.

In the third embodiment, the same reference signs as those of the components used in the previously shown embodiments are used, excluding where explicitly stated for a distinction. In addition, in the third embodiment, description that overlaps that of the previously shown embodiments is omitted as appropriate.

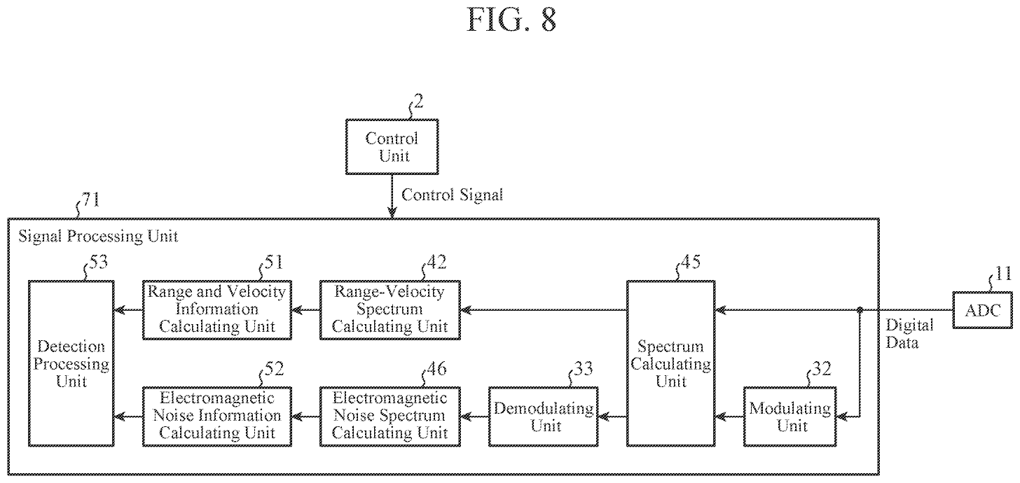

FIG. 8 is a configuration diagram showing a configuration of the signal processor 71 of the radar device 90 according to the third embodiment. As shown in FIG. 8, the signal processor 71 according to the third embodiment includes a modulator 32 and a demodulator 33 instead of the frequency converter 31 according to the first embodiment.

Operations of the radar device 90 unique to the third embodiment will become clear from the following description.

The modulator 32 shown in FIG. 8 identifies a period during which a radar signal is not outputted from the radar signal generator 1, by referring to a control signal outputted from the controller 2.

The modulator 32 performs a modulation process on digital data obtained during the period identified to have no radar signal out of digital data outputted from the analog-to-digital converter 11, and outputs the modulated digital data to a spectrum calculator 45.

Since digital data obtained during a period identified to have no radar signal is repeatedly outputted from the analog-to-digital converter 11, the modulator 32 performs a modulation process on each of the repeatedly outputted plurality of pieces of digital data. The plurality of pieces of digital data having been subjected to the modulation process each are outputted to the spectrum calculator 45.

The spectrum calculator 45 identifies a period during which a radar signal is outputted from the radar signal generator 1, by referring to the control signal outputted from the controller 2.

The spectrum calculator 45 adds together digital data (A) and digital data (B′) out of the digital data outputted from the analog-to-digital converter 11. The digital data (A) is digital data obtained during the period identified to have a radar signal being outputted. The digital data (B′) is the digital data obtained from the modulator 32.

The spectrum calculator 45 performs a range-FFT on the added data, thereby calculating a frequency spectrum.

During periods identified to have a radar signal being outputted, both digital data from the analog-to-digital converter 11 and digital data from the modulator 32 are repeatedly outputted. The spectrum calculator 45 repeatedly performs the above-described addition process.

The spectrum calculator 45 performs a range-FFT on each piece of the added digital data, thereby calculating a plurality of frequency spectra.

The spectrum calculator 45 outputs the calculated plurality of frequency spectra to the range-velocity spectrum calculator 42 and the demodulator 33.

The demodulator 33 performs a demodulation process on the frequency spectra outputted from the spectrum calculator 45, and outputs the demodulated frequency spectra to an electromagnetic noise spectrum calculator 46.

A frequency spectrum is repeatedly outputted from the spectrum calculator 45. The demodulator 33 performs a demodulation process on each of the repeatedly outputted plurality of frequency spectra. The plurality of frequency spectra having been subjected to the demodulation process are outputted to the electromagnetic noise spectrum calculator 46.

The electromagnetic noise spectrum calculator 46 obtains the plurality of frequency spectra outputted from the demodulator 33.

The electromagnetic noise spectrum calculator 46 performs a Doppler-FFT on the first half part of data corresponding to ½ or less of a sampling frequency fs out of the obtained plurality of frequency spectra. As a result, electromagnetic noise spectra are calculated.

The electromagnetic noise spectrum calculator 46 outputs the electromagnetic noise spectra to the electromagnetic noise information calculator 52.

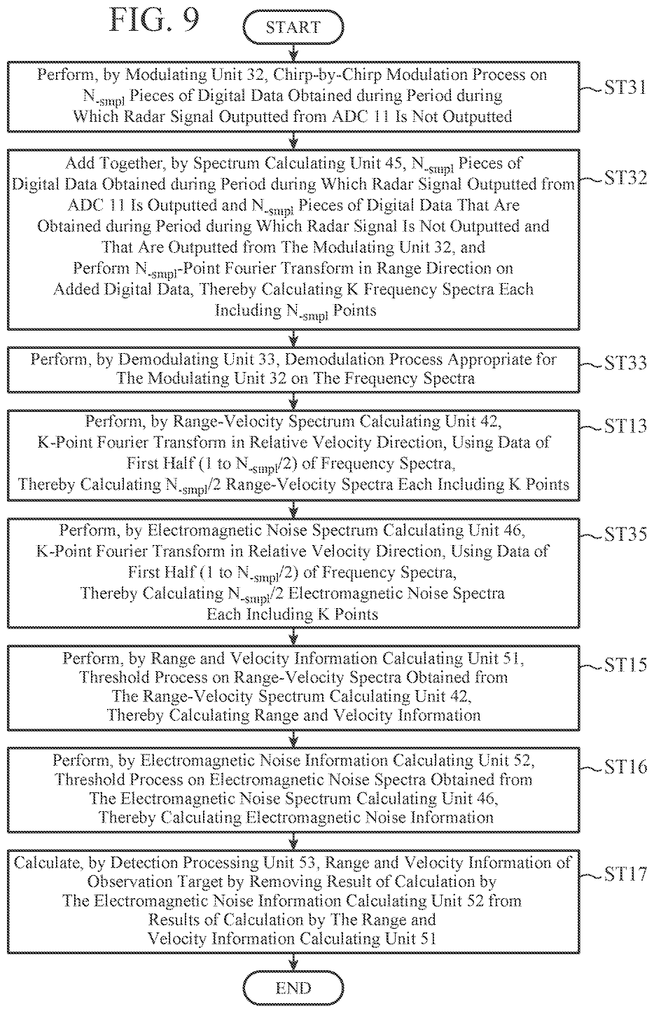

FIG. 9 is a flowchart showing a process of calculating range to an observation target and relative velocity with respect to the observation target that is performed by the signal processor 71 according to the third embodiment.

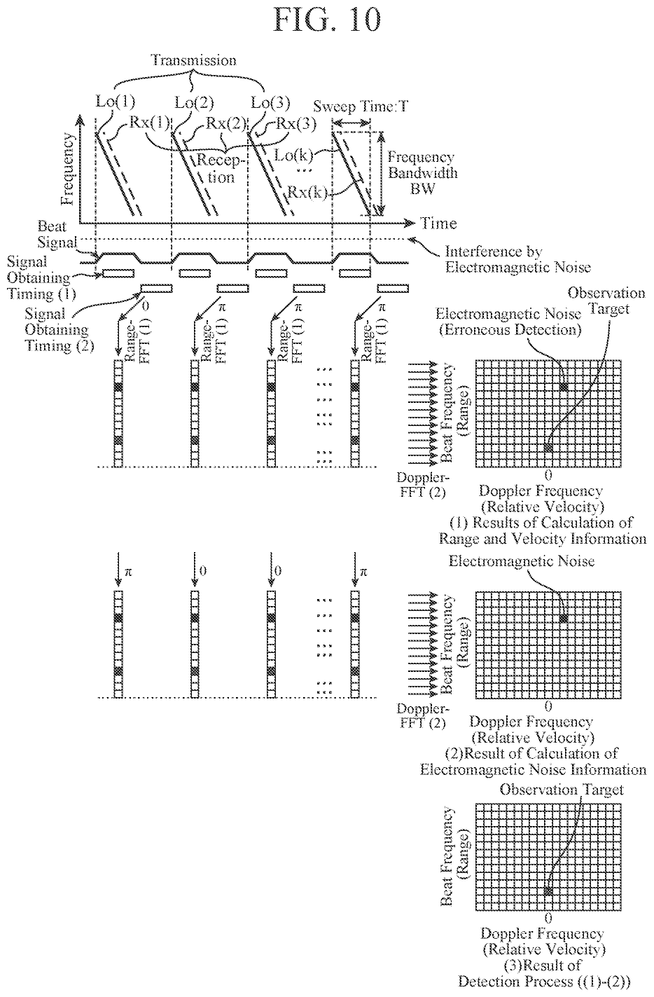

FIG. 10 is an explanatory diagram showing the process of calculating range to the observation target and relative velocity with respect to the observation target that is performed by the signal processor 71 according to the third embodiment.

The modulator 32 identifies a period during which a radar signal is not outputted from the radar signal generator 1, by referring to a control signal outputted from the controller 2.

The modulator 32 obtains digital data outputted from the analog-to-digital converter 11, at signal obtaining timing (2) included in the period identified to have no radar signal.

The modulator 32 performs a modulation process on Nₛₘₚₗ (an even number greater than or equal to 2) pieces of digital data obtained during the period identified to have no radar signal out of digital data outputted from the analog-to-digital converter 11 (step shown at ST31 of FIG. 9).

For simplification of description, FIG. 10 shows exemplary modulation in which multiplication by 1 or −1 is performed. However, this is merely an example and other modulation schemes may be used.

The spectrum calculator 45 identifies a period during which a radar signal is outputted from the radar signal generator 1, by referring to the control signal outputted from the controller 2.

The spectrum calculator 45 obtains digital data outputted from the analog-to-digital converter 11, at signal obtaining timing (1) included in the period identified to have a radar signal being outputted.

The spectrum calculator 45 adds together Nₛₘₚₗ pieces of digital data obtained during the period identified to have a radar signal being outputted out of the digital data outputted from the analog-to-digital converter 11, and the Nₛₘₚₗ pieces of digital data obtained from the modulator 32.

The spectrum calculator 45 performs an Nₛₘₚₗ-point range-FFT on the added digital data, thereby calculating a frequency spectrum (step shown at ST32 of FIG. 9).

In FIG. 10, FFT(1) represents a range-FFT. By performing a range-FFT on digital data, the spectrum value of a reflected-wave reception signal (Rx(k) (k=1, . . . , K)) is added up to a beat frequency (F_{sb_r}) shown in equation (1).

By the spectrum calculator 45 performing a range-FFT on digital data obtained at signal obtaining timing (1), the spectrum value of electromagnetic noise obtained during a period during which a radar signal is outputted is added up to a point at which the frequency of the electromagnetic noise is F_{n_r}.

By the spectrum calculator 45 performing a range-FFT on digital data obtained at signal obtaining timing (2), the spectrum value of electromagnetic noise obtained during a period during which a radar signal is not outputted is added up to the point at which the frequency of the electromagnetic noise is F_{n_r}.

As with the spectrum calculator 41 having a configuration shown in the first embodiment, the spectrum calculator 45 performs an Nₛₘₚₗ-point range-FFT on different sets of Nₛₘₚₗ pieces of digital data K times. By the K range-FFTs, K frequency spectra each including Nₛₘₚₗ points are calculated. The calculated frequency spectra are outputted to the range-velocity spectrum calculator 42 and the demodulator 33.

The demodulator 33 obtains the frequency spectra outputted from the spectrum calculator 45.

The demodulator 33 performs a demodulation process appropriate to the modulation process performed by the modulator 32 on the obtained frequency spectra (step shown at ST33 of FIG. 9).

For simplification of description, FIG. 10 shows an example in which demodulation is performed by multiplying 1 or −1 by which the data is multiplied in the modulation process by −1.

The demodulator 33 outputs demodulated first frequency spectra to the electromagnetic noise spectrum calculator 46.

The electromagnetic noise spectrum calculator 46 obtains the plurality of demodulated first frequency spectra outputted from the demodulator 33.

The range-velocity spectrum calculator 42 obtains the plurality of frequency spectra outputted from the spectrum calculator 45.

The range-velocity spectrum calculator 42 performs a K-point Doppler-FFT on data of the first half (1 to Nₛₘₚₗ/2) of the frequency spectra out of the obtained plurality of frequency spectra. As a result, range-velocity spectra each including K points are calculated (step shown at ST13 of FIG. 9).

In FIG. 10, FFT(2) represents a Doppler-FFT. By the range-velocity spectrum calculator 42 performing a Doppler-FFT on K frequency spectra, the spectrum value of a reflected-wave reception signal (Rx(k)) is added up to a Doppler frequency (F_{sb_v}) shown in equation (2):

To a Doppler frequency (F_{n_v}) corresponding to the relative velocity of the radar device 90 with respect to a source of electromagnetic noise generated during output of a radar signal is added up the spectrum value of the electromagnetic noise. In the example of FIG. 4 according to the first embodiment, continuous-wave electromagnetic noise is inputted to the analog-to-digital converter 11 and the frequency of the electromagnetic noise does not change, and thus, the spectrum value of the electromagnetic noise is added up to the frequency (F_{n_r}) of the electromagnetic noise.

In addition, a Doppler frequency corresponding to the relative velocity of the radar device 90 with respect to a source of electromagnetic noise generated at the time of no radar signal has been subjected to a modulation process and thus is spread without being added up.

FIG. 10 shows an example in which data of the first half (1 to Nₛₘₚₗ/2) of the first frequency spectra is used. The spectrum calculator 41 in the example performs a K-point Doppler-FFT on different K pieces of digital data Nₛₘₚₗ/2 times. By performing the Doppler-FFT, the spectrum calculator 45 calculates Nₛₘₚₗ/2 range-velocity spectra each including K points.

The range-velocity spectrum calculator 42 outputs the range-velocity spectra to the range and velocity information calculator 51.

The electromagnetic noise spectrum calculator 46 performs a K-point Doppler-FFT on data of the first half (1 to Nₛₘₚₗ/2) out of the obtained plurality of demodulated frequency spectra. By performing the Doppler-FFT, the electromagnetic noise spectrum calculator 46 calculates electromagnetic noise spectra each including K points (step shown at ST35 of FIG. 9).

In FIG. 10, FFT(3) represents a Doppler-FFT. The electromagnetic noise spectrum calculator 46 adds up, to a Doppler frequency (F_{n_v}) corresponding to the relative velocity of the radar device 90 with respect to a source of electromagnetic noise generated at the time of no radar signal, the spectrum value of the electromagnetic noise. In the example of FIG. 10, continuous-wave electromagnetic noise is inputted to the analog-to-digital converter 11 and the frequency of the electromagnetic noise does not change, and thus, the spectrum value of the electromagnetic noise is added up to the frequency (F_{n_r}) of the electromagnetic noise.

In FIG. 10, the spectrum value of the reflected-wave reception signal (Rx(k)) has been subjected to a demodulation process and thus the Doppler frequency is spread without being added up.

In addition, a Doppler frequency corresponding to the relative velocity of the radar device 90 with respect to a reception signal obtained during a period during which a radar signal is transmitted and an electromagnetic noise generation source has been subjected to a demodulation process and thus is spread without being added up.

FIG. 10 shows an example in which data of the first half (1 to Nₛₘₚₗ/2) of the frequency spectra is used. The electromagnetic noise spectrum calculator 46 in the example performs a K-point Doppler-FFT on different K pieces of digital data Nₛₘₚₗ/2 times. By performing the Doppler-FFT, the electromagnetic noise spectrum calculator 46 calculates Nₛₘₚₗ/2 electromagnetic noise spectra each including K points.

The electromagnetic noise spectrum calculator 46 outputs the electromagnetic noise spectra to the electromagnetic noise information calculator 52.

As described above, the radar device 90 according to the third embodiment has the above-described configuration, and thus, can collectively and simultaneously implement range-FFTs on digital data obtained during a period during which a radar signal is transmitted and during a period during which a radar signal is not transmitted. Thus, as with the radar devices 90 in the previously shown embodiments, the radar device 90 according to the third embodiment can reduce the number of Fourier transforms compared to conventional devices, enabling suppression of degradation of detection accuracy of an observation target.

### Fourth Embodiment

In the third embodiment, a configuration is such that a modulation process for digital data obtained during a period during which a radar signal is not transmitted is performed by the modulator 32 in the signal processor 71.

A radar device 90 according to a fourth embodiment includes a modulation processor 82. The modulation processor 82 may be constituted by, for example, an analog circuit.

In the fourth embodiment, the same reference signs as those of the components used in the previously shown embodiments are used, excluding where explicitly stated for a distinction. In addition, in the fourth embodiment, description that overlaps that of the previously shown embodiments is omitted as appropriate.

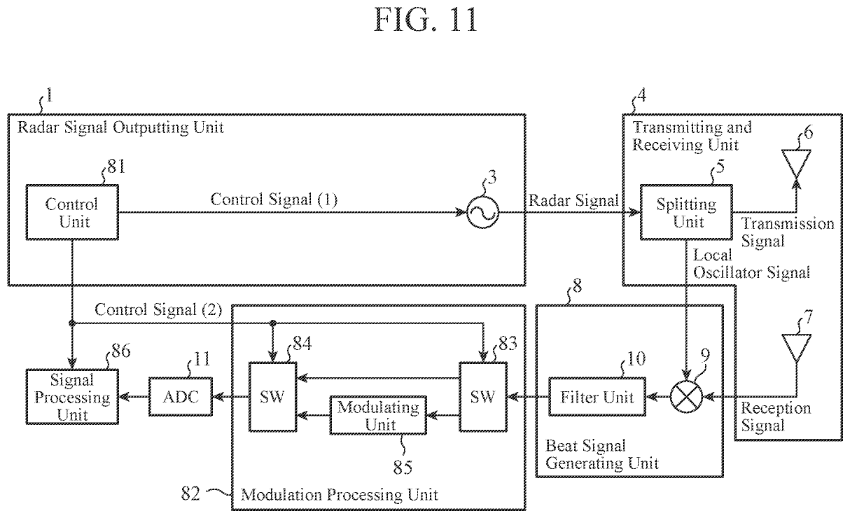

FIG. 11 is a configuration diagram showing a configuration of the radar device 90 according to the fourth embodiment. As shown in FIG. 11, the radar device 90 according to the fourth embodiment includes the modulation processor 82 in addition to the components in the first embodiment.

The modulation processor 82 includes a first switch 83, a second switch 84, and a modulator 85.

A controller 81 outputs a control signal (1) that instructs output of a radar signal, to the signal source 3. When the signal source 3 receives the control signal (1) from the controller 81, the signal source 3 outputs a continuous-wave frequency-modulated signal, as a radar signal, to the splitter 5.

In addition, the controller 81 outputs a control signal (2) indicating output timing of a radar signal, to each of the modulation processor 82 and a signal processor 86.

The first switch 83 is connected at its one end to one end on an output side of the second switch 84 and connected at its other end to an input side of the modulator 85.

The first switch 83 repeatedly switches to an input side of the second switch 84 during a period during which a radar signal is outputted, and to the input side of the modulator 85 during a period during which a radar signal is not outputted, in accordance with the output timing indicated by the control signal (2) outputted from the controller 81.

The modulator 85 performs a modulation process on a beat signal outputted from the first switch 83, thereby generating a second beat signal.

The modulator 85 outputs the generated second beat signal to the second switch 84.

The second switch 84 repeatedly switches to an output side of the first switch 83 during a period during which a radar signal is outputted, and to an output side of the modulator 85 during a period during which a radar signal is not outputted, in accordance with the output timing indicated by the control signal (2) outputted from the controller 81.

The second switch 84 outputs, to the analog-to-digital converter 11, the beat signal during the period during which a radar signal is outputted and the second beat signal during the period during which a radar signal is not outputted.

The signal processor 86 calculates each of range to an observation target and relative velocity with respect to the observation target, using digital data outputted from the analog-to-digital converter 11.

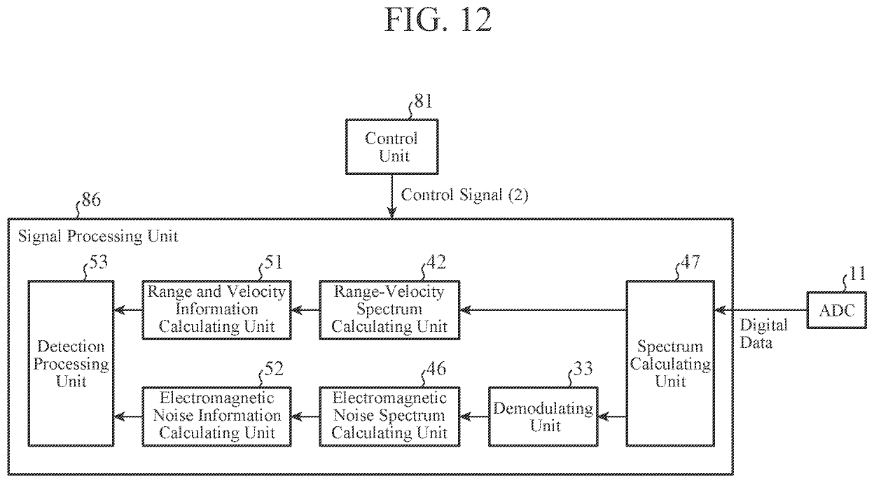

FIG. 12 is a configuration diagram showing a configuration of the signal processor 86 of the radar device 90 according to the fourth embodiment. Operations unique to the fourth embodiment will become clear from the following description with drawings.

A spectrum calculator 47 shown in FIG. 12 identifies a period during which a radar signal is outputted from the radar signal generator 1 and a period during which a radar signal is not outputted from the radar signal generator 1, by referring to a control signal (2) outputted from the controller 81.

The spectrum calculator 47 adds together digital data (A) and digital data (B) out of digital data outputted from the analog-to-digital converter 11. The digital data (A) is digital data obtained during the period identified to have a radar signal being outputted. The digital data (B) is digital data obtained during the period identified to have no radar signal.

The spectrum calculator 47 performs a range-FFT on the added data, thereby calculating a frequency spectrum.

Since digital data is repeatedly outputted from the analog-to-digital converter 11, the spectrum calculator 47 repeatedly adds together digital data (A) and digital data (B).

The spectrum calculator 47 performs a range-FFT on each piece of the added digital data, thereby calculating a plurality of frequency spectra.

The spectrum calculator 47 outputs the calculated plurality of frequency spectra to the range-velocity spectrum calculator 42 and the demodulator 33.

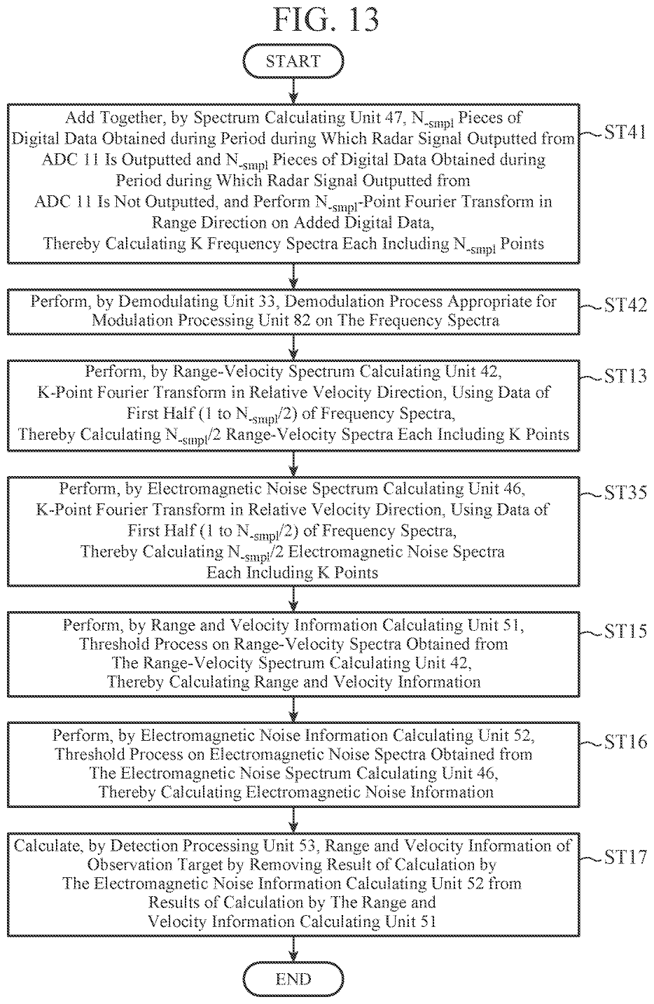

FIG. 13 is a flowchart showing a process of calculating range to the observation target and relative velocity with respect to the observation target that is performed by the signal processor 86 according to the fourth embodiment.

The spectrum calculator 47 identifies a period during which a radar signal is outputted from the radar signal generator 1 and a period during which a radar signal is not outputted from the radar signal generator 1, by referring to a control signal outputted from the controller 81.

The spectrum calculator 47 obtains digital data outputted from the analog-to-digital converter 11, at signal obtaining timing (1) included in the period identified to have a radar signal being outputted.

The spectrum calculator 47 obtains digital data outputted from the analog-to-digital converter 11, at signal obtaining timing (2) included in the period identified to have no radar signal.

The spectrum calculator 47 adds together digital data (A) and digital data (B) out of digital data outputted from the analog-to-digital converter 11. The digital data (A) is Nₛₘₚₗ pieces of digital data obtained during the period identified to have a radar signal being outputted. The digital data (B) is Nₛₘₚₗ pieces of digital data obtained during the period identified to have no radar signal.

The spectrum calculator 47 performs an Nₛₘₚₗ-point range-FFT on the added digital data, thereby calculating a frequency spectrum (step shown at ST41 of FIG. 13).

As with the spectrum calculator 45 having a configuration shown in the third embodiment, the spectrum calculator 47 performs an Nₛₘₚₗ-point range-FFT on different sets of Nₛₘₚₗ pieces of digital data K times, thereby calculating K first frequency spectra each including Nₛₘₚₗ points. The calculated frequency spectra are outputted to the range-velocity spectrum calculator 42 and the demodulator 33.

As described above, the radar device 90 according to the fourth embodiment has the above-described configuration, and thus, can collectively and simultaneously implement range-FFTs on digital data obtained during a period during which a radar signal is transmitted and during a period during which a radar signal is not transmitted. Thus, as with the radar devices 90 of the previously shown embodiments, the radar device 90 according to the fourth embodiment can reduce the number of Fourier transforms compared to conventional devices, enabling suppression of degradation of detection accuracy of an observation target.

### Fifth Embodiment

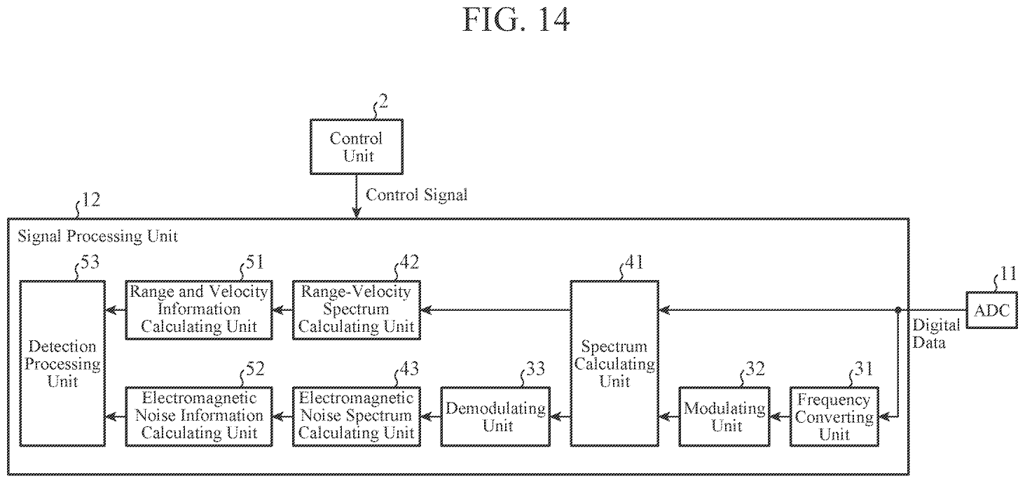

FIG. 14 is a configuration diagram showing a configuration of a signal processor 12 of a radar device 90 according to a fifth embodiment. As shown in FIG. 14, the signal processor 12 according to the fifth embodiment includes the components in the first embodiment and the components in the third embodiment all together. Specifically, the signal processor 12 according to the fifth embodiment includes the frequency converter 31, the modulator 32, the spectrum calculator 41, and the demodulator 33 in this order from the upstream side.

A configuration in which the first embodiment and the third embodiment are combined together is effective particularly when a folded peak frequency occurs in a range-FFT and when floor noise is large in a range-FFT.

As such, the fifth embodiment is a combination of the first embodiment and the third embodiment, but a combination of embodiments shown in this specification is not limited thereto.

A configuration in which the first embodiment and the fourth embodiment are combined together, the second embodiment and the third embodiment are combined together, the second embodiment and the fourth embodiment are combined together, or the like, is also effective particularly when a folded peak frequency occurs and when floor noise is large.

### Sixth Embodiment

A radar device 90 according to a sixth embodiment is characterized in an electromagnetic noise spectrum calculator 48. The electromagnetic noise spectrum calculator 48 according to the sixth embodiment limits a processing range of digital data for calculating a Doppler frequency (F_{n_v}) corresponding to relative velocity with respect to an electromagnetic noise generation source, on the basis of a beat frequency obtained by the range and velocity information calculator 51.

In the sixth embodiment, the same reference signs as those of the components used in the previously shown embodiments are used, excluding where explicitly stated for a distinction. In addition, in the sixth embodiment, description that overlaps that of the previously shown embodiments is omitted as appropriate.

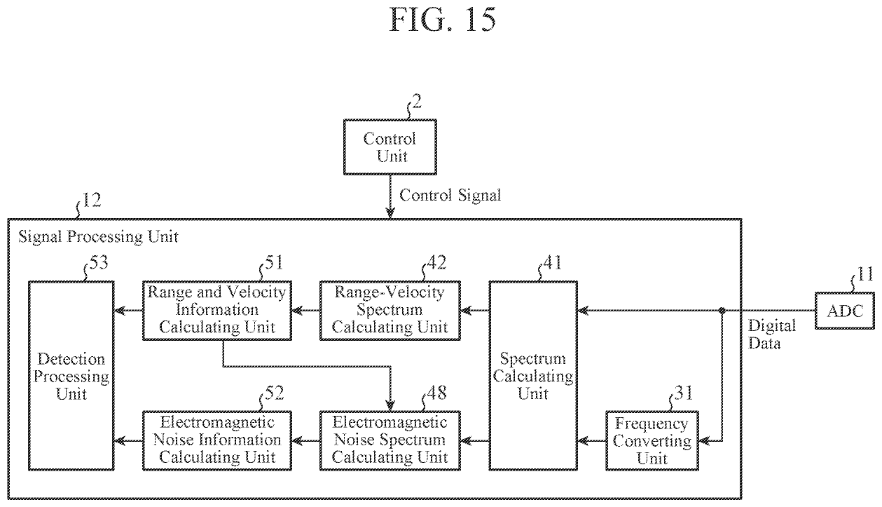

FIG. 15 is a configuration diagram showing a configuration of a signal processor 12 of the radar device 90 according to the sixth embodiment. As shown in FIG. 15, the signal processor 12 according to the sixth embodiment includes the electromagnetic noise spectrum calculator 48 unique to the sixth embodiment.

As in the first embodiment, the range and velocity information calculator 51 calculates two types of frequencies, using distance-velocity spectra obtained from the range-velocity spectrum calculator 42. The frequencies to be calculated are a beat frequency (F_{sb_r}) corresponding to range to an observation target and a Doppler frequency (F_{sb_v}) corresponding to relative velocity with respect to the observation target.

As in the first embodiment, the range and velocity information calculator 51 also detects, as a peak value, the spectrum value of electromagnetic noise obtained during a period during which a radar signal is outputted. Hence, the frequency (F_{n_r}) of the electromagnetic noise is also calculated as a beat frequency (F_{sb_r}) corresponding to the range to the observation target. In addition, the range and velocity information calculator 51 also calculates a Doppler frequency (F_{n_v}) corresponding to relative velocity with respect to an electromagnetic noise generation source, as a Doppler frequency (F_{sb_v}) corresponding to the relative velocity with respect to the observation target.

The range and velocity information calculator 51 outputs each of the calculated beat frequencies (F_{sb_r}) and the calculated Doppler frequencies (F_{sb_v}) to the detection processor 53.

In addition, the range and velocity information calculator 51 outputs the calculated beat frequencies (F_{sb_r}) to the electromagnetic noise spectrum calculator 48.

When one or more beat frequencies are inputted to the electromagnetic noise spectrum calculator 48 from the range and velocity information calculator 51, the electromagnetic noise spectrum calculator 48 limits a range of digital data of an obtained plurality of frequency spectra, on the basis of inputted beat frequency information, and performs a K-point Doppler-FFT. As a result, electromagnetic noise spectra each including K points are calculated.

The electromagnetic noise spectrum calculator 48 outputs the calculated electromagnetic noise spectra to the electromagnetic noise information calculator 52.

Operations of the signal processor 12 unique to the sixth embodiment will become clear from the following description. As described previously, the configuration of the signal processor 12 according to the sixth embodiment is the same as that in the first embodiment, except for the electromagnetic noise spectrum calculator 48. An operation unique to the sixth embodiment is a process of calculating a third frequency spectrum performed by the electromagnetic noise spectrum calculator 48.

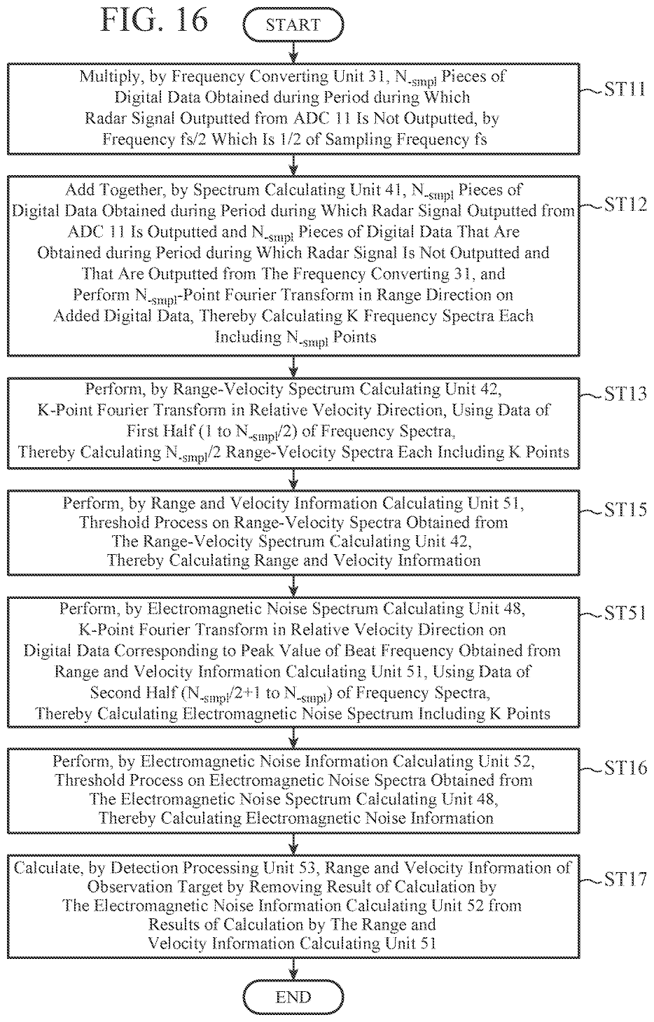

FIG. 16 is a flowchart showing a process of calculating range to the observation target and relative velocity with respect to the observation target that is performed by the signal processor 12 according to the sixth embodiment.

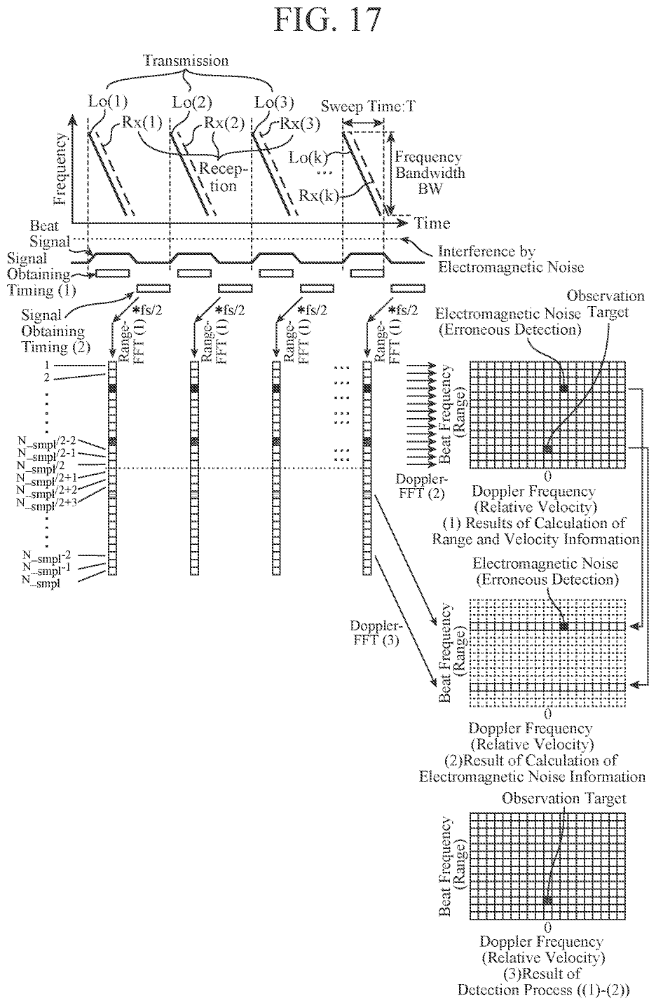

FIG. 17 is an explanatory diagram showing the process of calculating range to the observation target and relative velocity with respect to the observation target that is performed by the signal processor 12.

As in the first embodiment, the range and velocity information calculator 51 calculates each of a beat frequency (F_{sb_r}) corresponding to the range to the observation target and a Doppler frequency (F_{sb_v}) corresponding to the relative velocity with respect to the observation target.

As in the first embodiment, the range and velocity information calculator 51 outputs each of the calculated beat frequency (F_{sb_r}) and the calculated Doppler frequency (F_{sb_v}) to the detection processor 53.

In addition, the range and velocity information calculator 51 outputs information on the calculated beat frequency (F_{sb_r}) to the electromagnetic noise spectrum calculator 48.

When the range and velocity information calculator 51 outputs the information on the beat frequency (F_{sb_r}), the electromagnetic noise spectrum calculator 48 obtains the information on the beat frequency (F_{sb_r}).

When the spectrum calculator 41 outputs K frequency spectra, the electromagnetic noise spectrum calculator 48 obtains the K frequency spectra.

As in the first embodiment, the electromagnetic noise spectrum calculator 48 performs a Doppler-FFT on the obtained K frequency spectra, using only digital data corresponding to the information on the beat frequency (F_{sb_r}) inputted from the range and velocity information calculator 51. As a result, an electromagnetic noise spectrum related to electromagnetic noise is calculated (step shown at ST51 of FIG. 16).

In FIG. 17, FFT(3) represents a Doppler-FFT. The electromagnetic noise spectrum calculator 48 performs a Doppler-FFT on K first frequency spectra, using only digital data corresponding to information on a beat frequency (F_{sb_r}) inputted from the range and velocity information calculator 51. As a result, the spectrum value of electromagnetic noise is added up to a Doppler frequency (F_{n_v}) corresponding to the relative velocity with respect to an electromagnetic noise generation source.

FIG. 17 exemplifies a case in which there are two pieces of beat frequency information obtained from the range and velocity information calculator 51. In this case, a Doppler-FFT is performed on digital data at two points, by which two electromagnetic noise spectra are calculated.

The electromagnetic noise spectrum calculator 48 outputs the two calculated electromagnetic noise spectra to the electromagnetic noise information calculator 52.

As described above, the radar device 90 according to the sixth embodiment has the above-described configuration, and thus, has a small number of Fourier transforms compared to the configuration shown in the first embodiment, enabling suppression of degradation of detection accuracy of an observation target. In addition, even if a mode described in the sixth embodiment is used in any of the second to fifth embodiments, the same advantageous effect can be obtained.

### Seventh Embodiment

An in-vehicle device according to a seventh embodiment is an in-vehicle device having mounted thereon a radar device 90 according to the techniques of the present disclosure exemplified in the first to sixth embodiments.

In the seventh embodiment, the same reference signs as those of the components used in the previously shown embodiments are used, excluding where explicitly stated for a distinction. In addition, in the seventh embodiment, description that overlaps that of the previously shown embodiments is omitted as appropriate.

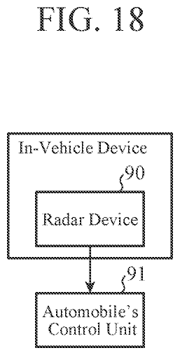

FIG. 18 is a configuration diagram showing a configuration of the in-vehicle device according to the seventh embodiment. As shown in FIG. 18, the in-vehicle device includes the radar device 90. In addition, the radar device 90 is configured to transmit output results to an automobile's controller 91 provided external to the in-vehicle device.

The radar device 90 outputs, to the automobile's controller 91, each of range to an observation target and relative velocity with respect to the observation target that are calculated by the detection processor 53.

In addition, the radar device 90 outputs, to the automobile's controller 91, each of a frequency (F_{n_r}) of electromagnetic noise and a Doppler frequency (F_{n_v}) corresponding to relative velocity with respect to an electromagnetic noise generation source that are calculated by the electromagnetic noise information calculator 52.

The automobile's controller 91 is a device that controls an engine, steering, a brake, or the like, of an automobile.

Operations of the in-vehicle device according to the seventh embodiment will become clear from the following description.

When the detection processor 53 calculates each of range to the observation target and relative velocity with respect to the observation target, the radar device 90 outputs each of the range to the observation target and the relative velocity with respect to the observation target to the automobile's controller 91.

A frequency (F_{n_r}) of electromagnetic noise and a Doppler frequency (F_{n_v}) each are calculated by the electromagnetic noise information calculator 52. The radar device 90 outputs each of the calculated frequency (F_{n_r}) of electromagnetic noise and Doppler frequency (F_{n_v}) to the automobile's controller 91.

The automobile's controller 91 determines, for example, collision risk of an automobile including the in-vehicle device with the observation target, on the basis of each of the range to the observation target and the relative velocity with respect to the observation target that are obtained from the radar device 90. For a method of determining collision risk, any determination method may be used. The automobile's controller 91 may use publicly known determination methods.

When the automobile's controller 91 determines that there is collision risk, the automobile's controller 91 may, for example, automatically activate a brake of the automobile.

In addition, when the automobile's controller 91 determines that there is collision risk, the automobile's controller 91 may, for example, control steering so that a traveling direction of the automobile changes.

In addition, the automobile's controller 91 may, for example, perform autonomous driving of the automobile, on the basis of sensor information detected by a sensor which is not shown and a combination of the obtained range to the observation target and the obtained relative velocity with respect to the observation target.

The automobile's controller 91 may be configured to determine reliability, on the basis of each of the frequency (F_{n_r}) of electromagnetic noise and Doppler frequency (F_{n_v}) outputted from the radar device 90. A target whose reliability is to be determined may be, for example, each of the obtained range to the observation target and the obtained relative velocity with respect to the observation target. A method of determining reliability may be any determination method. The automobile's controller 91 may use publicly known determination methods.

When the automobile's controller 91 determines that the reliability is high, the automobile's controller 91 may, for example, perform autonomous driving of the automobile, using each of the obtained range to the observation target and the obtained relative velocity with respect to the observation target.

When the automobile's controller 91 determines that the reliability is low, the automobile's controller 91 may, for example, not use each of the obtained range to the observation target and the obtained relative velocity with respect to the observation target, upon performing autonomous driving of the automobile.

As described above, the in-vehicle device according to the seventh embodiment has the above-described configuration, and thus, the automobile's controller 91 that uses information from the radar device 90 can determine collision risk, enabling an increase in reliability in autonomous driving.

### INDUSTRIAL APPLICABILITY

The techniques of the present disclosure can be applied to radar devices and in-vehicle devices including a radar device, and have industrial applicability.

### REFERENCE SIGNS LIST

1: radar signal generator, 2: controller (first, third, fifth, and sixth embodiments), 3: signal source, 4: transmitting and receiving antenna, 5: splitter, 6: transmission antenna, 7: reception antenna, 8: beat signal generator, 9: frequency mixer, 10: filter, 11: analog-to-digital converter, 12: signal processor (first, fifth, and sixth embodiments), 31: frequency converter (first, fifth, and sixth embodiments), 32: modulator (third and fifth embodiments), 33: demodulator (third, fourth, and fifth embodiments), 41: spectrum calculator (first, fifth, and sixth embodiments), 42: range-velocity spectrum calculator, 43: electromagnetic noise spectrum calculator (first, second, and fifth embodiments), 44: spectrum calculator (second embodiment), 45: spectrum calculator (third embodiment), 46: electromagnetic noise spectrum calculator (third and fourth embodiments), 47: spectrum calculator (fourth embodiment), 48: electromagnetic noise spectrum calculator (sixth embodiment), 51: range and velocity information calculator, 52: electromagnetic noise information calculator, 53: detection processor, 61: controller (second embodiment), 62: frequency converter (second embodiment), 63: first switch (second embodiment), 64: second switch (second embodiment), 65: frequency mixer (second embodiment), 66: filter (second embodiment), 67: second signal source (second embodiment), 68: signal processor (second embodiment), 71: signal processor (third embodiment), 81: controller (fourth embodiment), 82: modulation processor (fourth embodiment), 83: first switch (fourth embodiment), 84: second switch (fourth embodiment), 85: modulator (fourth embodiment), 86: signal processor (fourth embodiment), 90: radar device, and 91: automobile's controller.

What is claimed is:

1. A radar device comprising:
a radar signal generator to intermittently and repeatedly output a chirp as a radar signal;
a transmitting and receiving antenna to transmit the radar signal and receive, as a reflected wave, the radar signal reflected from an observation target;
a beat signal generator to generate a beat signal from the radar signal and the reflected wave;
an analog-to-digital converter to convert the beat signal into digital data; and
a signal processor to detect range to the observation target and relative velocity with respect to the observation target, using the digital data, wherein
the signal processor includes:
a frequency converter to perform frequency conversion on a part of the digital data that is obtained during a period during which the radar signal is not outputted;
a spectrum calculator to add together a part of the digital data that is obtained during a period during which the radar signal is outputted and the digital data having been subjected to the frequency conversion by the frequency converter, and perform a range-FFT on the added digital data;
a range-velocity spectrum calculator to perform a Doppler-FFT on a first half part of results obtained by the spectrum calculator performing the range-FFT; and
an electromagnetic noise spectrum calculator to perform a Doppler-FFT on a second half part of the results obtained by the spectrum calculator performing the range-FFT.

2. A radar device comprising:
a radar signal generator to intermittently and repeatedly output a chirp as a radar signal;
a transmitting and receiving antenna to transmit the radar signal and receive, as a reflected wave, the radar signal reflected from an observation target;
a beat signal generator to generate a beat signal from the radar signal and the reflected wave;
a frequency converter to perform frequency conversion only on a part of the beat signal that is obtained during a period during which the radar signal is not outputted;
an analog-to-digital converter to convert analog signals into digital signals, the analog signals to be converted are the beat signal obtained during period where the radar signal is outputted, and the signal that has been frequency converted by the frequency converter; and
a signal processor to detect range to the observation target and relative velocity with respect to the observation target, using the digital data, wherein
the signal processor includes:
a spectrum calculator to add together a part of the digital data that is obtained during a period during which the radar signal is outputted and the digital data having been subjected to the frequency conversion by the frequency converter, and perform a range-FFT on the added digital data;
a range-velocity spectrum calculator to perform a Doppler-FFT on a first half part of results obtained by the spectrum calculator performing the range-FFT; and
an electromagnetic noise spectrum calculator to perform a Doppler-FFT on a second half part of the results obtained by the spectrum calculator performing the range-FFT.

3. The radar device according to claim 1, wherein
a modulator and a demodulator are provided instead of the frequency converter,
the modulator performs a modulation process on the part of the digital data that is obtained during the period during which the radar signal is not outputted, and
the demodulator performs a demodulation process on the digital data outputted from the spectrum calculator.

4. The radar device according to claim 3, wherein the modulation process is frequency conversion.

5. The radar device according to claim 1, wherein when one or more beat frequencies are calculated as the results of the range-FFT, the electromagnetic noise spectrum calculator performs a Doppler-FFT only on a part of the digital data that corresponds to the beat frequencies.

6. An in-vehicle device comprising a radar device according to claim 1.
